(19) United States
(12) Patent Application Publication
(10) Pub. No.: US 2025/0174997 A1
(43) Pub. Date: May 29, 2025

(54) A METHOD FOR CONTROLLING A POWER PLANT

(71) Applicant: VESTAS WIND SYSTEMS A/S, Aarhus N (DK)

(72) Inventors: Mads Rajczyk SKJELMOSE, Risskov (DK); Dumitru-Mihai VALCAN, Langå (DK)

(21) Appl. No.: 18/843,048

(22) PCT Filed: Feb. 21, 2023
(86) PCT No.: PCT/DK2023/050027

§ 371 Date: Aug. 30, 2024

(30) Foreign Application Priority Data
Mar. 2, 2022 (DK) PA202270082

(51) Int. Cl. H02J 3/24; F03D 7/04; F03D 9/25; H02P 9/02

(52) U.S. Cl. CPC H02J 3/24; F03D 7/048; F03D 9/257; H02P 9/02; H02J 2300/28

(57) ABSTRACT

A method for controlling a power plant comprising one or more wind turbine generators and one or more Power-to-X units, the Power-to-X unit being configured to convert electric power from the power plant to X, the power plant being connected to an electric power grid. The method comprises: in response to an under-frequency support request with regard to the electric power grid, determining to initiate an inertia emulation response period of the one or more wind turbine generators so as to increase the electric power generation of the wind turbine generator for providing frequency support to the electric power grid; and when or after it has been determined to initiate the inertia emulation response period, initiating an electric power consumption reduction period of the Power-to-X unit so as to reduce the electric power consumption of the Power-to-X unit to a lower level or zero.

### TECHNICAL FIELD

Aspects of the present invention relate to a method for controlling a power plant comprising one or more wind turbine generators, the power plant being connected to an electric power grid.

### BACKGROUND

In general, an electric power grid, for example referred to as a utility grid, may have defined parameters, for example a defined frequency, such as 50 Hz or 60 Hz. The stability of the electric power grid parameters is dependent on a variety of variables including the balance between generated electric power and consumed electric power in the electric power grid. In general, any imbalance between generated electric power and consumed electric power results in changes in the grid frequency of the electric power grid. When more electric power is generated than consumed in the electric power grid, the grid frequency increases. When more electric power is consumed than generated, the grid frequency decreases. In general, it is important to have a stable grid frequency in the electric power grid, i.e. to keep the frequency fluctuations of the grid frequency as small as possible. In general, a grid code may be specified for an electric power grid, wherein the grid code defines parameters a power plant connected to the electric power grid has to meet, such as a power plant including one or more wind turbine generators, for example to provide sufficient frequency support to the electric power grid.

### SUMMARY

The inventors of the present invention have found drawbacks in conventional solutions for power plants, which include one or more wind turbine generators, to provide frequency support to the electric power grid. For example, some conventional solutions do not provide a sufficiently efficient frequency support to the electric power grid.

An object of the invention is to provide a solution which mitigates or solves the drawbacks and problems of conventional solutions.

The above and further objects are solved by the subject matter of the independent claims. Further advantageous embodiments of the invention can be found in the dependent claims.

According to a first aspect of the invention, the above mentioned and other objects are achieved with a method for controlling a power plant comprising one or more wind turbine generators and one or more Power-to-X units, the Power-to-X unit being configured to convert electric power from the power plant to X, the power plant being connected to an electric power grid, wherein the method comprises:
in response to an under-frequency support request with regard to the electric power grid, determining to initiate an inertia emulation response period of the one or more wind turbine generators so as to increase the electric power generation of the wind turbine generator for providing frequency support to the electric power grid; and
when or after it has been determined to initiate the inertia emulation response period, initiating an electric power consumption reduction period of the one or more Power-to-X units so as to reduce the electric power consumption of the one or more Power-to-X units to a lower level or zero.

In general, the increasing penetration of variable-speed wind turbine generators in the electric power grid results in a reduction of the portion of connected conventional power plants including conventional large synchronous generators, which leads to a reduction of inertia in the electric power grid, since a conventional large synchronous generator provides an inertia response for providing frequency support to the electric power grid, while, in general, a variable-speed wind turbine generator is connected to the electric power via one or more power converters, i.e. the variable-speed wind turbine generator is decoupled from the electric power grid by one or more power converters, whereby the wind turbine generator cannot provide a true inertia response for providing frequency support to the electric power grid. However, conventional control schemes may be applied to a variable-speed wind turbine generator, which make the variable-speed wind turbine generator provide a so-called virtual inertia response, or an inertia emulation response, for providing frequency support to the electric power grid. During a frequency drop in the electric power grid, additional electric power may thus be released from the variable-speed wind turbine generator to the electric power grid by way of one or more of said conventional control schemes applied to the variable-speed wind turbine generator so as to provide frequency support to the electric power grid. Said additional electric power is obtained from the kinetic or rotational energy stored in the rotating mass, or rotor, of the wind turbine generator, which in general results in a slowing down of the rotor of the wind turbine generator.

An advantage of the method according to the first aspect is an improved frequency support provided by a power plant, which includes one or more wind turbine generators, to the electric power grid. An advantage of the method according to the first aspect is that a rapid or fast frequency support provided by the power plant to the electric power grid is provided. An advantage of the method according to the first aspect is that the frequency support provided by the power plant to the electric power grid and involving an inertia emulation response of the wind turbine generator is improved. An advantage of the method according to the first aspect is that the power drop of the wind turbine generator during a recovery for the wind turbine generator to regain rotational energy lost during the inertia emulation response subsequent to an initial period of the inertia emulation response is efficiently counteracted or reduced, since the electric power grid is compensated with or by electric power resulting from the electric power consumption reduction of the Power-to-X unit. An advantage of the method according to the first aspect is that the process for the wind turbine generator to regain rotational energy lost during an inertia emulation response is efficiently improved, since the electric power grid is compensated with or by electric power resulting from the electric power consumption reduction of the Power-to-X unit.

It is to be understood that for some embodiments, there may be a delay, or no delay, before the electric power consumption reduction period of the one or more Power-to-X units is initiated after it has been determined to initiate the inertia emulation response period. For some embodiments, “X” with regard to the Power-to-X unit may comprise or consist of one or more fuels.

According to an advantageous embodiment of the method according to the first aspect, the method comprises:
after it has been determined to initiate the inertia emulation response period, initiating the inertia emulation response period; and
when or after the inertia emulation response period is or has been initiated, initiating the electric power consumption reduction period of the one or more Power-to-X units.

An advantage of this embodiment is that the frequency support provided by the power plant to the electric power grid is further improved. It is to be understood that for some embodiments, there may be a delay, or no delay, before the electric power consumption reduction period of the one or more Power-to-X units is initiated after the inertia emulation response period has been initiated. For alternative embodiments, instead the method may comprise the step of: before initiating the inertia emulation response period, initiating the electric power consumption reduction period of the one or more Power-to-X units.

According to a further advantageous embodiment of the method according to the first aspect, the inertia emulation response period comprises a recovery period for the wind turbine generator to regain rotational energy lost during the inertia emulation response period, and wherein the method comprises:
determining to initiate the recovery period of the one or more wind turbine generators; and
when or after it has been determined to initiate the recovery period, initiating the electric power consumption reduction period of the one or more Power-to-X units. An advantage of this embodiment is that the frequency support provided by the power plant to the electric power grid is further improved. An advantage of this embodiment is that the frequency support provided by the power plant to the electric power grid and involving an inertia emulation response of the wind turbine generator is further improved. An advantage of this embodiment is that the counteraction or reduction of the power drop of the wind turbine generator during the recovery period is further improved. An advantage of this embodiment is that the process for the wind turbine generator to regain rotational energy during the recovery period is further improved. It is to be understood that for some embodiments, there may be a delay, or no delay, before the electric power consumption reduction period of the one or more Power-to-X units is initiated after it has been determined to initiate the recovery period.

According to another advantageous embodiment of the method according to the first aspect, the method comprises:
after it has been determined to initiate the recovery period, initiating the recovery period of the one or more wind turbine generators; and
before initiating the recovery period, initiating the electric power consumption reduction period of the one or more Power-to-X units.

An advantage of this embodiment is that the frequency support provided by the power plant to the electric power grid is further improved.

According to yet another advantageous embodiment of the method according to the first aspect, the method comprises:
after it has been determined to initiate the recovery period, initiating the recovery period of the one or more wind turbine generators; and
when or after the recovery period is or has been initiated, initiating the electric power consumption reduction period of the one or more Power-to-X units. An advantage of this embodiment is that the frequency support provided by the power plant to the electric power grid is further improved. It is to be understood that for some embodiments, there may be a delay, or no delay, before the electric power consumption reduction period of the one or more Power-to-X units is initiated after the recovery period has been initiated.

According to still another advantageous embodiment of the method according to the first aspect, the method comprises:
terminating the recovery period of the one or more wind turbine generators; and
before terminating the recovery period, initiating the electric power consumption reduction period of the one or more Power-to-X units.

An advantage of this embodiment is that the frequency support provided by the power plant to the electric power grid is further improved.

According to an advantageous embodiment of the method according to the first aspect, the method comprises:
terminating the inertia emulation response period; and
before terminating the inertia emulation response period, initiating the electric power consumption reduction period of the one or more Power-to-X units.

An advantage of this embodiment is that the frequency support provided by the power plant to the electric power grid is further improved.

According to a further advantageous embodiment of the method according to the first aspect, the method comprises:
terminating the inertia emulation response period; and
when or after the inertia emulation response period is or has been terminated, terminating the electric power consumption reduction period of the one or more Power-to-X units.

An advantage of this embodiment is that the frequency support provided by the power plant to the electric power grid is further improved.

According to another advantageous embodiment of the method according to the first aspect, the electric power consumption reduction period comprises an initial period and a subsequent period subsequent to the initial period,
wherein the method comprises:
during the initial period, gradually reducing the electric power consumption of the one or more Power-to-X units to the lower level or zero.

An advantage of this embodiment is that the frequency support provided by the power plant to the electric power grid is further improved by the gradual reduction of the electric power consumption of the one or more Power-to-X units. An advantage of this embodiment is that the control of the frequency support provided to the electric power grid is improved.

According to yet another advantageous embodiment of the method according to the first aspect, the electric power consumption reduction period comprises an initial period and a subsequent period subsequent to the initial period,
wherein the method comprises:
during the subsequent period, gradually increasing the electric power consumption of the one or more Power-to-X units from the lower level or zero.

An advantage of this embodiment is that the frequency support provided by the power plant to the electric power grid is further improved by the gradual increase of the electric power consumption of the one or more Power-to-X units. An advantage of this embodiment is that the control of the frequency support provided to the electric power grid is improved.

According to still another advantageous embodiment of the method according to the first aspect, the Power-to-X unit comprises a power-to-gas unit configured to convert electric power from the power plant to gas. An advantage of this embodiment is that the frequency support provided by the power plant to the electric power grid is further improved.

According to an advantageous embodiment of the method according to the first aspect, the power-to-gas unit is configured to convert electric power from the power plant to a gas or gas mixture comprising or consisting of one or more of the group of:
hydrogen;
oxygen; and
methane.

An advantage of this embodiment is that the frequency support provided by the power plant to the electric power grid is further improved.

According to a further advantageous embodiment of the method according to the first aspect, the power-to-gas unit comprises an electrolyzer system comprising one or more of the group of:
an alkaline electrolyzer;
an unpressurized alkaline electrolyzer;
a pressurized alkaline electrolyzer;
a proton exchange membrane electrolyzer;
an unpressurized proton exchange membrane electrolyzer;
a pressurized proton exchange membrane electrolyzer;
a polymer electrolyte membrane electrolyzer;
an unpressurized polymer electrolyte membrane electrolyzer;
a pressurized polymer electrolyte membrane electrolyzer; and
a solid oxide electrolyzer.

An advantage of this embodiment is that the frequency support provided by the power plant to the electric power grid is further improved.

According to another advantageous embodiment of the method according to the first aspect, the method comprises receiving the under-frequency support request. An advantage of this embodiment is that the frequency support provided by the power plant to the electric power grid is further improved.

According to yet another advantageous embodiment of the method according to the first aspect, the under-frequency support request comprises one or more references, wherein the method comprises:
producing one or more set points based on the one or more references; and
providing the one or more set points to the one or more wind turbine generators and/or to the one or more Power-to-X units.

An advantage of this embodiment is that the frequency support provided by the power plant to the electric power grid is further improved.

According to still another advantageous embodiment of the method according to the first aspect, the under-frequency support request is triggered by one or more of the group of:
an operating frequency of the electric power grid being below a predetermined reference frequency by a predetermined frequency value; and
an operating frequency of the electric power grid dropping with a frequency gradient having a change over time with a magnitude which exceeds a predetermined magnitude of change.

An advantage of this embodiment is that the frequency support provided by the power plant to the electric power grid is further improved.

According to an advantageous embodiment of the method according to the first aspect, wherein the Power-to-X unit is connected to a connection point of the wind turbine generator. An advantage of this embodiment is that the frequency support provided by the power plant to the electric power grid is further improved.

According to a further advantageous embodiment of the method according to the first aspect, the Power-to-X unit is connected to a connection point of the power plant. An advantage of this embodiment is that the frequency support provided by the power plant to the electric power grid is further improved.

According to another advantageous embodiment of the method according to the first aspect, the Power-to-X unit is connected to a connection point of the point of common coupling, PCC, between the power plant and the electric power grid. An advantage of this embodiment is that the frequency support provided by the power plant to the electric power grid is further improved.

According to still another advantageous embodiment of the method according to the first aspect, the method comprises:
at least before the electric power consumption reduction period, providing the Power-to-X unit with electric power from one or more of the group of:
the power plant;
a power source of the power plant;
a power generator of the power plant; and
the wind turbine generator.

An advantage of this embodiment is that the frequency support provided by the power plant to the electric power grid is further improved.

According to yet another advantageous embodiment of the method according to the first aspect, the Power-to-X unit is configured to convert electric power to X from one or more of the group of:
a power source of the power plant;
a power generator of the power plant; and
the wind turbine generator.

An advantage of this embodiment is that the frequency support provided by the power plant to the electric power grid is further improved.

According to a second aspect of the invention, the above mentioned and other objects are achieved with a computer program comprising instructions which, when the program is executed by a computer, cause the computer to carry out the method according to any one of the embodiments disclosed above or below. Advantages of the computer program according to the second aspect correspond to advantages of the method according to the first aspect and its embodiments mentioned above or below.

According to a third aspect of the invention, the above mentioned and other objects are achieved with a computer-readable medium comprising instructions which, when the instructions are executed by a computer, cause the computer to carry out the method according to any one of the embodiments disclosed above or below. Advantages of the computer-readable medium according to the third aspect correspond to advantages of the method according to the first aspect and its embodiments mentioned above or below.

According to an aspect of the present invention, the above-mentioned computer program and/or the computer-readable medium are/is configured to implement the method and its embodiments described herein.

According to a fourth aspect of the invention, the above mentioned and other objects are achieved with a control arrangement for controlling a power plant comprising one or more wind turbine generators and one or more Power-to-X units, the Power-to-X unit being configured to convert electric power from the power plant to X, the power plant being connected to an electric power grid, wherein the control arrangement is configured to:
in response to an under-frequency support request with regard to the electric power grid, determine to initiate an inertia emulation response period of the one or more wind turbine generators so as to increase the electric power generation of the wind turbine generator for providing frequency support to the electric power grid; and
when or after it has been determined to initiate the inertia emulation response period, initiate an electric power consumption reduction period of the one or more Power-to-X units so as to reduce the electric power consumption of the one or more Power-to-X units to a lower level or zero.

Advantages of the control arrangement according to the fourth aspect correspond to advantages of the method according to the first aspect and its embodiments mentioned above or below.

It is to be appreciated that all the embodiments described for the method aspects of the invention are applicable also to the control arrangement aspects of the invention. Thus, all embodiments described for the method aspects of the invention may be performed by the control arrangement, which may include one or more controllers, control units, or control devices. The embodiments of the control arrangement have advantages corresponding to advantages mentioned above for the method and its embodiments.

According to a fifth aspect of the invention, the above mentioned and other objects are achieved with a power plant for providing electric power to an electric power grid, wherein the power plant comprises
one or more wind turbine generators,
one or more Power-to-X units configured to convert electric power from the power plant to X, and
a control arrangement according to any one of the embodiments disclosed above or below.

Advantages of the power plant according to the fifth aspect correspond advantages of the method according to the first aspect and its embodiments mentioned above or below.

The above-mentioned features and embodiments of the method, the computer program, the computer-readable medium, the control arrangement and the power plant, respectively, may be combined in various possible ways providing further advantageous embodiments.

Further advantageous embodiments of the method, the computer program, the computer-readable medium, the control arrangement and the power plant according to the present invention and further advantages with the embodiments of the present invention emerge from the detailed description of embodiments.

### BRIEF DESCRIPTION OF THE DRAWINGS

Embodiments of the invention will now be illustrated, for exemplary purposes, in more detail by way of embodiments and with reference to the enclosed drawings, where similar references are used for similar parts, in which:

FIG. 1 is a schematic diagram illustrating an embodiment of the power plant according to the fifth aspect of the invention, to which embodiments of the method according to the first aspect of the invention may be applied;

FIG. 2 is a schematic diagram illustrating an embodiment of a wind turbine generator of the power plant of FIG. 1;

FIG. 3 is a schematic diagram illustrating an embodiment of a Power-to-X unit of the power plant of FIG. 1;

FIG. 4 is a schematic flow chart illustrating aspects of embodiments of the method according to the first aspect of the invention;

FIG. 5 is another schematic flow chart illustrating further aspects of embodiments of the method according to the first aspect of the invention;

FIG. 6 is another schematic flow chart illustrating other aspects of embodiments of the method according to the first aspect of the invention;

FIG. 7 is a schematic diagram including schematic graphs illustrating an inertia emulation response of a wind turbine generator according to conventional technology;

FIG. 8 is a schematic diagram including schematic graphs illustrating aspects of embodiments of the method according to the first aspect of the invention;

FIG. 9 is a schematic diagram including schematic graphs illustrating further aspects of embodiments of the method according to the first aspect of the invention;

FIG. 10 is a schematic diagram including schematic graphs illustrating other aspects of embodiments of the method according to the first aspect of the invention; and

FIG. 11 is a schematic diagram illustrating an embodiment of the control arrangement according to the fourth aspect of the invention, in which a method according to any one of the herein described embodiments may be implemented.

### DETAILED DESCRIPTION

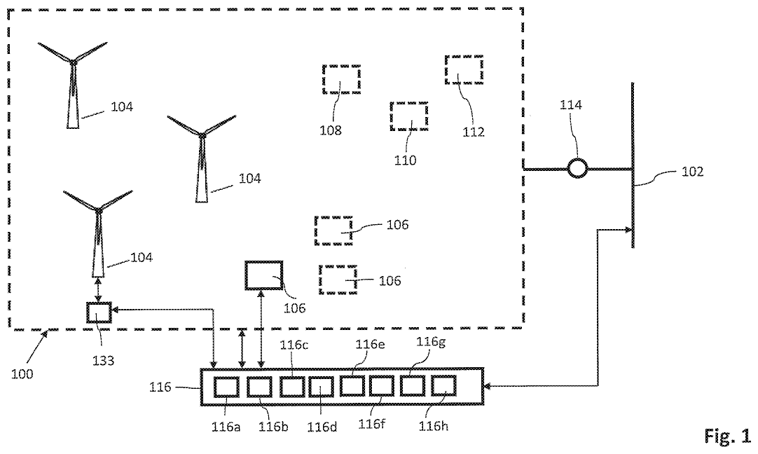

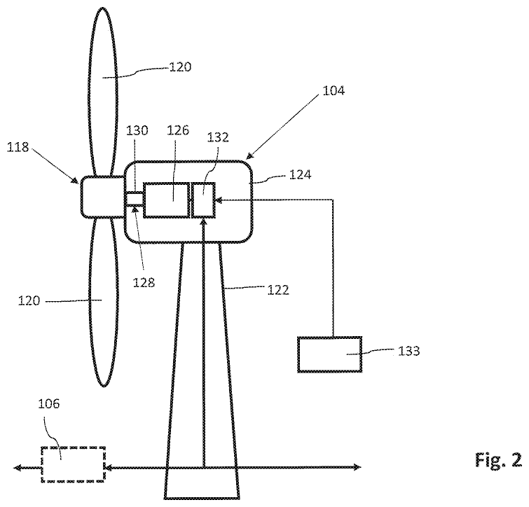

With reference to FIG. 1, an embodiment of the power plant 100 for providing electric power, or electrical energy, to an electric power grid 102 according to the fifth aspect of the invention is schematically illustrated. For example, embodiments of the method according to the first aspect of the invention may be applied to the power plant 100 illustrated in FIG. 1. However, embodiments of the method according to the first aspect may also be applied to other power plants. The power plant 100 includes one or more wind turbine generators 104, for example two, three or more wind turbine generators 104. Aspects of an embodiment of the wind turbine generator 104 are disclosed in further detail hereinbelow in connection with FIG. 2.

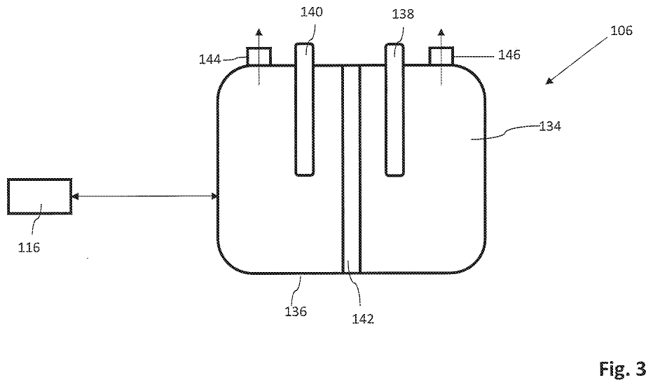

With reference to FIG. 1, the power plant 100 includes one or more Power-to-X units 106 configured to convert electric power from the power plant 100 to X. Expressed alternatively, the Power-to-X unit 106 may be described to be configured to convert electric power to X from the power plant 100, or the Power-to-X unit may be configured to convert electric power, which is from or generated by the power plant 100, to X. Aspects of an embodiment of the Power-to-X unit 106 are disclosed in further detail hereinbelow in connection with FIG. 3.

With reference to FIG. 1, for some embodiments, the wind turbine generator 104 may be described as a power source of the power plant 100 or as a power generator of the power plant 100. For some embodiments, the power plant 100 may include one or more additional power sources or power generators, such as solar cell panels/photo-voltaic panels 108, fuel cells 110 and/or electric battery units 112. For some embodiments, the power plant 100 may be referred to as a hybrid power plant. The power plant 100 may be connected, or connectable, to the electric power grid 102 via a point of common coupling, PCC, 114. For some embodiments, the electric power grid 102 may be referred to as a utility grid, an electrical grid, or an electric power network. For example, the power plant 100 may be located offshore or on land.

With reference to FIG. 1, the power plant 100 includes a control arrangement 116 for controlling the power plant 100 according to any one of the embodiments disclosed above or below and/or according to the fourth aspect of the invention. The control arrangement 116 may comprise, or be referred to as, a power plant controller, PPC. The control arrangement 116 is further disclosed hereinbelow.

With reference to FIG. 2, an embodiment of the wind turbine generator 104 of the power plant 100 of FIG. 1 is schematically illustrated. The wind turbine generator 104 may comprise a rotor 118 including one or more blades 120, or rotor blades 120, for example two or more blades 120, such as three blades 120, or more. The wind turbine generator 104 may comprise a tower 122 and a nacelle 124 mounted to the top of the tower 122. The rotor 118 may be connected, such as rotatably connected or mounted, to the nacelle 124. The wind turbine generator 104 may comprise an electric generator 126 to which the rotor 118 is connected. The rotor 118 is configured to drive the electric generator 126. The nacelle 124 may house the electric generator 126.

With reference to FIG. 2, the rotor 118 is rotatable by action of the wind. The wind-induced rotational energy of the blades 120 and rotor 118 may be transferred via a coupling 128, for exampling including one or more shafts 130, to the electric generator 126. Thus, the wind turbine generator 104 may be described to be configured to convert kinetic energy of the wind to mechanical energy, or rotational energy, by way of the blades 120 and, subsequently, to electric power by way of the electric generator 126. The wind turbine generator 104 may comprise one or more power converters 132 connected to the electric generator 126. The wind turbine generator 104 and/or the electric generator 126 may be connected to the electric power grid 102 via said one or more power converters 132. The one or more power converters 132 may comprise a first power converter for converting AC power from the electric generator 126 to DC power. The one or more power converters 132 may comprise a second power converter for converting DC power from the first power converter to AC power to be provided to the electric power grid 102. The nacelle 124 may house the one or more power converters 132, or the one or more power converters 132 may be located elsewhere.

With reference to FIG. 2, the wind turbine generator 104 may comprises a control arrangement 133 for controlling the wind turbine generator 104. The control arrangement 133 of the wind turbine generator 104 may comprise a wind turbine generator controller. The control arrangement 133 of the wind turbine generator 104 may be configured to communicate with and/or be connected to, or be part of, the control arrangement 116 of the power plant 100. For some embodiments, the wind turbine generator 104 may be referred to as a variable-speed wind turbine generator. It is to be understood that the wind turbine generator 104 may include further unites, components and/or devices, such as sensors, required for a wind turbine generator 104. For some embodiments, and as schematically illustrated in FIG. 2, the Power-to-X unit 106 may be connected, more specifically electrically connected, to a connection point of the wind turbine generator 102. For some embodiments, the wind turbine generator 102 and the Power-to-X unit 106 may be arranged together as a unit. However, for some embodiments, the Power-to-X unit 106 may be located and/or connected elsewhere in the power plant 100.

With reference to FIG. 3, an embodiment of the Power-to-X (P2X) unit 106 of the power plant 100 of FIG. 1 is schematically illustrated. For some embodiments, “X” with regard to the Power-to-X unit may comprise or consist of one or more fuels. In FIG. 3, the Power-to-X unit 106 comprises and is illustrated as a power-to-gas (P2G) unit 134 configured to convert electric power from the power plant 100 to gas. For some embodiments, the power-to-gas unit 134 may be configured to convert electric power from the power plant 110 to, or configured to use electric power to produce, a gas or gas mixture comprising or consisting of one or more of the group of: hydrogen; oxygen; and methane. In the embodiment illustrated in FIG. 3, the power-to-gas unit 134 is configured to convert electric power from the power plant 100 to a gas mixture comprising hydrogen and oxygen. The power-to-gas unit 134 may be described to be configured to use electricity to break water into hydrogen and oxygen in a process called electrolysis. Thus, through the electrolysis, hydrogen is created, which may be used as a fuel. The power-to-gas unit 134 may include a container 136 configured to hold or contain water. The power-to-gas unit 134 may include one or more anodes 138 and one or more cathodes 140 separated from one another by a membrane 142. The container 136 may include an outlet 144 for hydrogen and an outlet 146 for oxygen.

With reference to FIG. 3, for some embodiments, the power-to-gas unit 134 comprises an electrolyzer system comprising one or more of the group of:
an alkaline electrolyzer;
an unpressurized alkaline electrolyzer;
a pressurized alkaline electrolyzer;
a proton exchange membrane electrolyzer;
an unpressurized proton exchange membrane electrolyzer;
a pressurized proton exchange membrane electrolyzer;
a polymer electrolyte membrane electrolyzer;
an unpressurized polymer electrolyte membrane electrolyzer;
a pressurized polymer electrolyte membrane electrolyzer; and
a solid oxide electrolyzer (SOEC).

With reference to FIG. 3, for some embodiments, the unpressurized alkaline electrolyzer may have a power ramp up rate of approximately 10% per minute and a power ramp down rate of approximately 20% per minute. For some embodiments, the pressurized alkaline electrolyzer may have a power ramp up rate of approximately 200% per minute and a power ramp down rate of approximately 200% per minute. For some embodiments, the pressurized proton exchange membrane electrolyzer or the pressurized polymer electrolyte membrane electrolyzer may have a power ramp up rate of approximately 20% per second and a power ramp down rate of approximately 20% per second. The above-mentioned % levels are in relation to the nominal power of the respective electrolyzer.

With reference to FIGS. 2 and 3, for some embodiments, the Power-to-X unit 106 may be connected, more specifically electrically connected, to a connection point of the wind turbine generator 104. For some embodiments, the Power-to-X unit 106 may be connected, more specifically electrically connected, to a connection point of the power plant 100. For some embodiments, the Power-to-X unit 106 may be connected, more specifically electrically connected, to a connection point of the point of common coupling (PCC) 114 between the power plant 100 and the electric power grid 102.

With reference to FIG. 3, for some embodiments, the Power-to-X unit 106 may be configured to convert electric power to X from one or more of the group of: a power source of the power plant 100; a power generator of the power plant 100; and the wind turbine generator 104. It is to be understood that the Power-to-X unit 106 may include further unites, components and/or other devices, such as pumps, vents, storage tanks and/or separators, required for a Power-to-X unit 106. It is to be understood that other embodiments of the Power-to-X unit 106 than the one disclosed in FIG. 3 are possible.

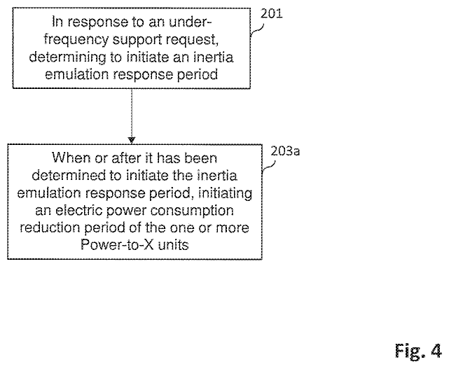

With reference to FIGS. 4 to 6, aspects of embodiments of the method for controlling a power plant 100 according to the first aspect of the invention are schematically illustrated, wherein the power plant 100 includes one or more wind turbine generators 104 and one or more Power-to-X units 106, wherein the Power-to-X unit 106 is configured to convert electric power from, or generated by, the power plant 100 to X, and wherein the power plant 100 is connected, or connectable, to an electric power grid 102

With reference to FIG. 4, embodiments of the method include the steps of:
in response to an under-frequency support request with regard to the electric power grid 102, for example an under-frequency support request from the electric power grid 102, determining 201 to initiate, or start, an inertia emulation response period of the one or more wind turbine generators 104 (or determining 201 that an inertia emulation response period is to be initiated) so as to increase the electric power generation or output of the wind turbine generator 104 for providing frequency support to the electric power grid 102; and
when or after it has been determined to initiate the inertia emulation response period, initiating 203a, or starting, an electric power consumption reduction period of the one or more Power-to-X units 106 so as to reduce the electric power consumption of the one or more Power-to-X units 106 to a lower level or zero, for example from a first or higher level to the lower level or zero.

With reference to FIG. 4, for some embodiments, the method may include the step of controlling the Power-to-X unit 106 to counteract or reduce the power drop of the wind turbine generator 104 during a recovery for the wind turbine generator 104 to regain rotational energy lost during the inertia emulation response subsequent to an initial period of the inertia emulation response, since the electric power grid 102 is compensated with or by electric power resulting from the electric power consumption reduction of the Power-to-X unit 106. Hereby, the frequency support provided by the power plant 100 to the electric power grid 102 is improved. It is to be understood that for some embodiments, there may be a delay, or no delay, before the electric power consumption reduction period of the one or more Power-to-X units 106 is initiated 203a after it has been determined 201 to initiate the inertia emulation response period. The fact that the electric power consumption of the Power-to-X unit 106 is zero implies that the Power-to-X unit 106 consumes no electric power or consumes substantially no electric power. For some embodiments, during or within the electric power consumption reduction period of the one or more Power-to-X units 106, the electric power consumption of the one or more Power-to-X units 106 may be gradually reduced to the lower level or zero.

With reference to FIG. 4, for some embodiments, the inertia emulation response period may be referred to as a virtual inertia response period. It is to be understood that within the inertia emulation response period, an inertia emulation response is provided or performed by the wind turbine generator 104 so as to provide frequency support to the electric power grid 102. By way of the inertia emulation response, the electric power generation or output of the wind turbine generator 104 is increased, such as rapidly increased, and the increased and/or additional electric power may be provided to the electric power grid 102 for frequency support. However, in general, the inertia emulation response and the resulting additional electric power output from the wind turbine generator 104 may only continue for a limited period. As a result of the inertia emulation response and the additional electric power to the electric power grid 102, in general, the wind turbine generator 104, such as the rotor 118, loses rotational energy (or stored kinetic energy) and/or is slowed down. For some embodiments, an inertia emulation response of a wind turbine generator 104 may be described as an extraction, or an additional extraction, of stored kinetic energy from the rotor 118 and a conversion of the extracted stored kinetic energy to additional electric power output to the electric power grid 102 for frequency support, which in general results in a slowing down of the rotor 118. After the inertia emulation response, in order to return the wind turbine generator 104 to a more optimal operation, the wind turbine generator 104 should, in general, regain the rotational energy lost during the inertia emulation response, for example during a recovery period. There are several conventional control schemes for the wind turbine generator 104 to perform an inertia emulation response known to the person skilled in the art, so as to provide frequency support to the electric power grid.

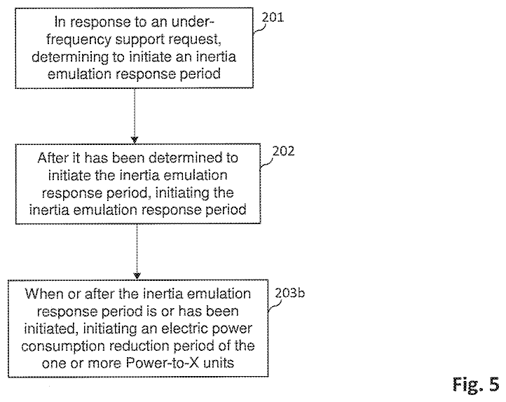

With reference to FIG. 5, some embodiments of the method may include the steps of:
in response to an under-frequency support request with regard to the electric power grid 102, determining 201 to initiate the inertia emulation response period of the one or more wind turbine generators 104;
after it has been determined to initiate the inertia emulation response period, initiating 202 the inertia emulation response period; and.
when or after the inertia emulation response period is or has been initiated, initiating 203b the electric power consumption reduction period of the one or more Power-to-X units 106.

With reference to FIG. 5, it is to be understood that for some embodiments, there may be a delay, or no delay, before the electric power consumption reduction period of the one or more Power-to-X units is initiated 203b after the inertia emulation response period has been initiated 202.

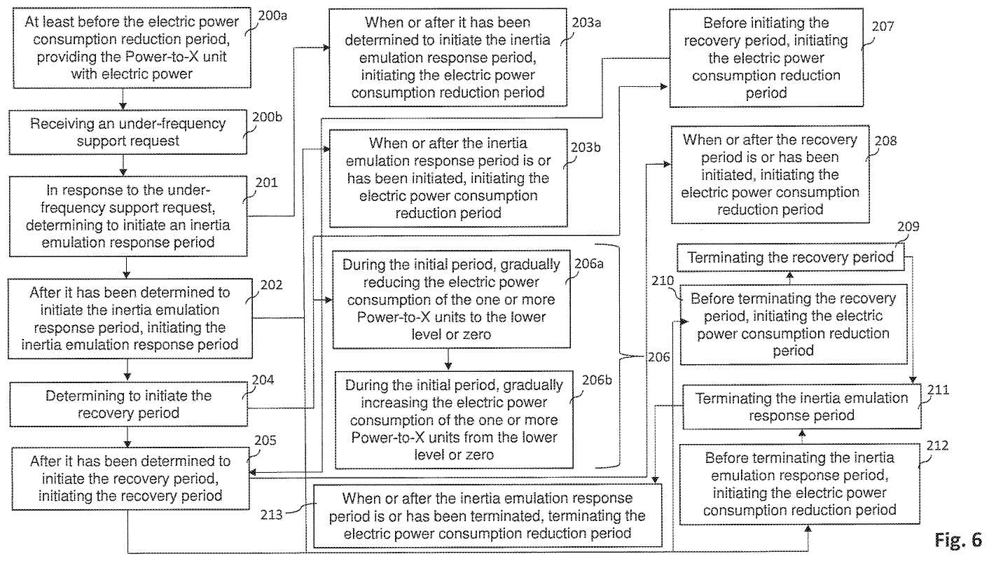

With reference to FIG. 6, wherein the inertia emulation response period may comprise a recovery period for the wind turbine generator to regain rotational energy (or rotational kinetic energy or angular kinetic energy) lost during the inertia emulation response period, and wherein the electric power consumption reduction period may comprise an initial period and a subsequent period subsequent to the initial period, some embodiments of the method may include one or more of the steps of:
at least before the electric power consumption reduction period, providing 200a the Power-to-X unit 106 with electric power from one or more of the group of: the power plant 100; a power source of the power plant 100; a power generator of the power plant 100; and the wind turbine generator 104;
receiving 200b an under-frequency support request with regard to the electric power grid 102, for example from the electric power grid 102, or from a controller of the electric power grid 102;
in response to the under-frequency support request, determining 201 to initiate the inertia emulation response period of the one or more wind turbine generators 104;
after it has been determined to initiate the inertia emulation response period, initiating 202 the inertia emulation response period;
determining 204 to initiate the recovery period of the one or more wind turbine generators 104;
after it has been determined to initiate the recovery period, initiating 205 the recovery period of the one or more wind turbine generators 104;
when or after it has been determined to initiate the inertia emulation response period, initiating 203a the electric power consumption reduction period of the one or more Power-to-X units 106;
when or after the inertia emulation response period is or has been initiated, initiating 203b the electric power consumption reduction period of the one or more Power-to-X units 106;
when or after it has been determined to initiate the recovery period, initiating 206 the electric power consumption reduction period of the one or more Power-to-X units 106;
before initiating the recovery period, initiating 207 the electric power consumption reduction period of the one or more Power-to-X units 106;
when or after the recovery period is or has been initiated, initiating 208 the electric power consumption reduction period of the one or more Power-to-X units 106;
terminating 209 the recovery period of the one or more wind turbine generators 104;
before terminating the recovery period, initiating 210 the electric power consumption reduction period of the one or more Power-to-X units;
terminating 211 the inertia emulation response period;
before terminating the inertia emulation response period, initiating 212 the electric power consumption reduction period of the one or more Power-to-X units 106; and
when or after the inertia emulation response period is or has been terminated, terminating 213 the electric power consumption reduction period of the one or more Power-to-X units 104.

With reference to FIG. 6, it is to be understood that for some embodiments, there may be a delay, or no delay, before the electric power consumption reduction period of the one or more Power-to-X units is initiated 206 after it has been determined 204 to initiate the recovery period. It is to be understood that for some embodiments, there may be a delay, or no delay, before the electric power consumption reduction period of the one or more Power-to-X units is initiated 208 after the recovery period has been initiated 205.

With reference to FIG. 6, some embodiments of the method may include one or more of the steps of:
during the initial period, gradually reducing 206a the electric power consumption of the one or more Power-to-X units to the lower level or zero; and.
during the subsequent period, gradually increasing 206b the electric power consumption of the one or more Power-to-X units from the lower level or zero.

It is be understood that although steps 206a and 206b are only illustrated for step 206 in FIG. 6, steps 206a and 206b may be applied to one or more of the other steps 203a, 203b, 207, 208, 210 and 212 regarding the initiation of the electric power consumption reduction period of the one or more Power-to-X units 106 in FIGS. 4 to 6.

With reference to FIG. 6, some embodiments of the method may include the step of controlling the Power-to-X unit 106 to counteract or reduce the power drop, or dip, of the wind turbine generator 104 during the recovery period, since the electric power grid 102 is compensated with or by electric power resulting from the electric power consumption reduction of the Power-to-X unit 106.

For some embodiments, wherein the under-frequency support request comprises one or more references, the method may include the steps of:
producing one or more set points based on the one or more references; and
providing, or sending, the one or more set points to the one or more wind turbine generators 104 and/or to the one or more Power-to-X units 106.

For some embodiments, the under-frequency support request may be triggered by one or more situations or events of the group of:
an operating frequency of the electric power grid 102 being below a predetermined reference frequency by a predetermined frequency value; and
an operating frequency of the electric power grid 102 dropping with a frequency gradient having a change over time with a magnitude which exceeds a predetermined magnitude of change.

For some embodiments, the predetermined magnitude of change may be greater than 0.1 Hz/s. For some embodiments, the predetermined magnitude of change may be between 0.2 to 7 Hz/s. For some embodiments, the predetermined magnitude of change may be between 0.5 to 2 Hz/s. For some embodiments, the predetermined reference frequency may be 50 Hz or 60 Hz, and the predetermined frequency value may be greater than 2%. For some embodiments, the predetermined frequency value may be greater than 3%. However, other levels or thresholds than those mentioned above are possible.

Unless disclosed otherwise, it should be noted that the method steps illustrated in FIGS. 4 to 6 and described herein do not necessarily have to be executed in the order illustrated in FIGS. 4 to 6. The steps may essentially be executed in any suitable order. Further, one or more steps may be added without departing from the scope of the appended claims. One or more steps may be excluded without departing from the scope of the appended claims.

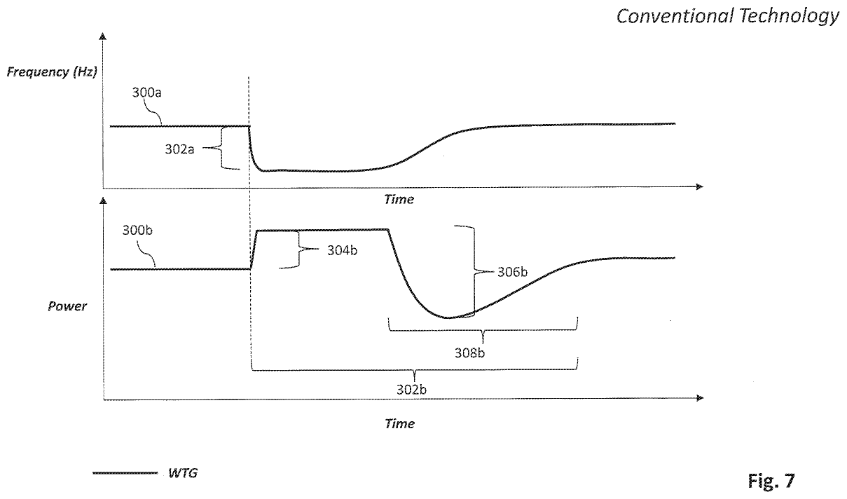

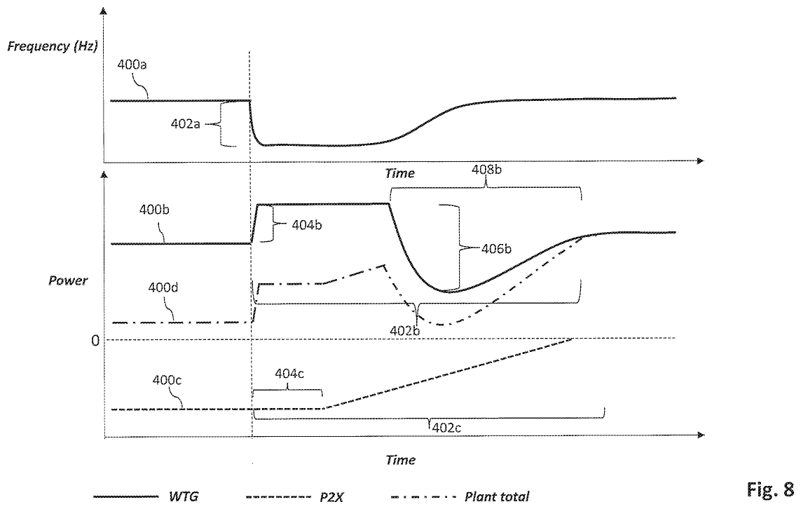

In FIG. 7, schematic graphs illustrating an inertia emulation response of a wind turbine generator according to conventional technology are shown, while in FIGS. 8 to 10, schematic graphs illustrating aspects of embodiments of the method according to the first aspect of the invention are shown.

With reference to FIG. 7, the graph 300a schematically illustrates the frequency (grid frequency) of an electric power grid to which a wind turbine generator is connected and schematically illustrates an under-frequency deviation or event 302a in the electric power grid. The graph 300b schematically illustrates the electric power provided by the wind turbine generator to the electric power grid. In response to the under-frequency event 302a, the wind turbine generator is controlled to start an inertia emulation response to support to the electric power grid during an inertia emulation response period 302b. During the inertia emulation response period 302b, stored kinetic energy is extracted from the rotor of the wind turbine generator and converted to additional electric power which is outputted to the electric power grid for frequency support, which is illustrated by a rapid increase 304b of the electric power output from the wind turbine generator. Said extraction of stored kinetic energy from the rotor results in a slowing down of the rotor, which results in a power drop 306b during a recovery period 308b following an initial period of the inertia emulation response period 302b. During the recovery period 308b the wind turbine generator is controlled to regain rotational energy lost during the inertia emulation response in order to return to more optimal operation. After the recovery period 308b, the wind turbine generator has returned to optimal operation. During the inertia emulation response period 302b and during the recovery period 308b, the wind turbine generator is controlled according to one or more conventional control schemes.

With reference to FIG. 8, the graphs 400a, 400b, 400c, 400c schematically illustrate aspects of embodiments of the method according to the first aspect. The graph 400a schematically illustrates the frequency (grid frequency) of the electric power grid 100 to which the wind turbine generator 104 is connected and schematically illustrates an under-frequency deviation or event 402a in the electric power grid 100. The graph 400b schematically illustrates the electric power provided by the wind turbine generator 104 to the electric power grid 100. Upon the under-frequency event 402a, the wind turbine generator 104 is controlled to start an inertia emulation response to support to the electric power grid 100 during the inertia emulation response period 402b. During the inertia emulation response period 402b, stored kinetic energy is extracted from the rotor 118 of the wind turbine generator 104 and converted to additional electric power which is outputted to the electric power grid 100 for frequency support, which is illustrated by a rapid increase 404b of the electric power output from the wind turbine generator 104. Said extraction of stored kinetic energy from the rotor results in a slowing down of the rotor 118, which results in a power drop 406b during the recovery period 408b following an initial period of the inertia emulation response period 402b. During the recovery period 408b, the wind turbine generator 104 is controlled to regain rotational energy lost during the inertia emulation response period 402b in order to return to more optimal operation. After the recovery period 408b, in general, the wind turbine generator 104 is returned to optimal operation. However, in accordance with embodiments of the method according to the first aspect, after the inertia emulation response period 402b has been initiated, the electric power consumption reduction period 402c of the Power-to-X unit 106 is initiated, in FIG. 8 with a delay 404c, which is schematically illustrated by the graph 400c. By way of the electric power consumption reduction period 402c, during which the electric power consumption of the Power-to-X unit 106 is gradually reduced to a lower level, the power drop 406b of the wind turbine generator 104 during the recovery period 408b is counteracted or reduced, since the electric power grid 102 is compensated with or by electric power resulting from the electric power consumption reduction of the Power-to-X unit 106.

The graph 400d schematically illustrates the power output from the entire power plant 100 to the electric power grid 102.

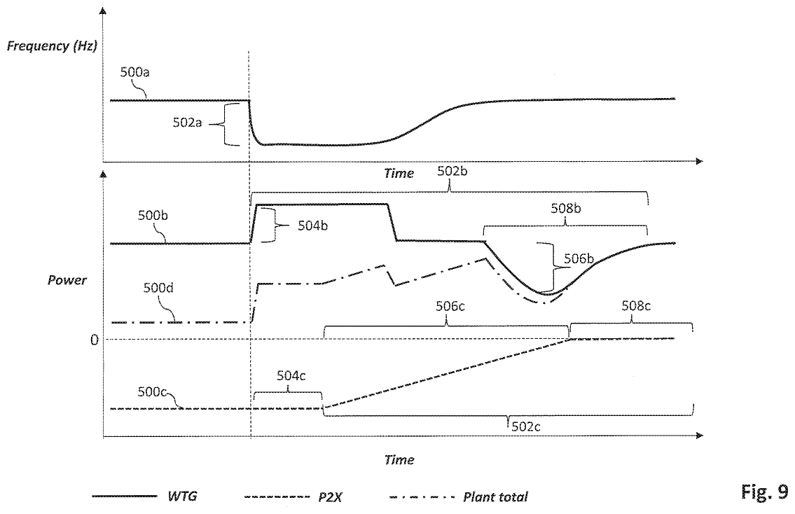

With reference to FIG. 9, the graphs 500a, 500b, 500c, 500c schematically illustrate further aspects of embodiments of the method according to the first aspect. The graph 500a schematically illustrates the frequency (grid frequency) of the electric power grid 100. The graph 500b schematically illustrates the electric power provided by the wind turbine generator 104 to the electric power grid 100. In response to an under-frequency event 502a, the wind turbine generator 104 is controlled to start an inertia emulation response to support to the electric power grid 100 during the inertia emulation response period 502b, which involves a rapid increase 504b of the electric power output and a recovery period 508b following an initial period of the inertia emulation response period 502b. The graph 500c schematically illustrates that the electric power consumption reduction period 502c of the Power-to-X unit 106 is initiated with a delay 504c after the inertia emulation response period 502b has been initiated. Further, the graph 500c schematically illustrates that the electric power consumption reduction period 502c comprises an initial period 506c and a subsequent period 508c subsequent to the initial period 506c. As schematically illustrated by the graph 500c, during the initial period 506c, the electric power consumption of the Power-to-X unit 106 is gradually reduced to the lower level, while during the subsequent period 508c, the electric power consumption of the Power-to-X unit 106 is maintained at the lower level and may thereafter be gradually increased from the lower level. The effect by the electric power consumption reduction period 502c of FIG. 9, is that the power drop 506b of the wind turbine generator 104 during the inertia emulation response period 502b or during the recovery period 508b is delayed, or can be delayed, in relation to the power drop 406b of the wind turbine generator 104 of FIG. 8. Further, for some embodiments, the power drop 506b of the wind turbine generator 104 during the recovery period 508b in FIG. 9 may be further reduced in relation to the power drop 406b of the wind turbine generator 104 of FIG. 8. The graph 500d schematically illustrates the power output from the entire power plant 100 to the electric power grid 102.

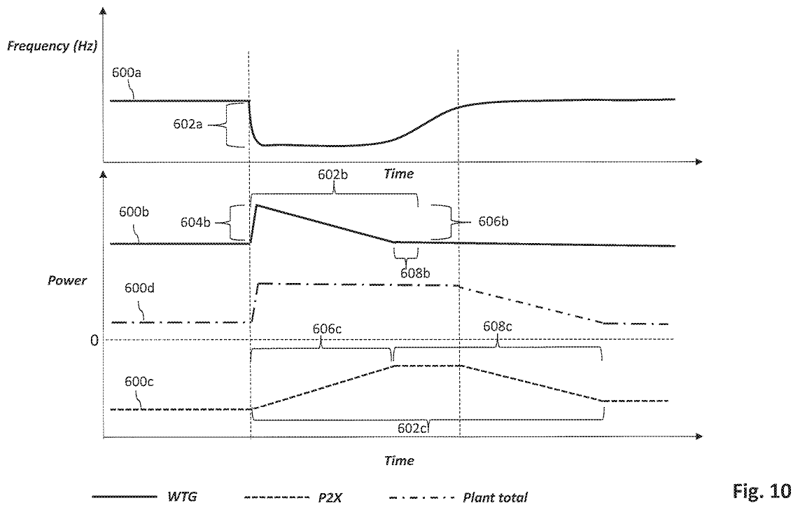

With reference to FIG. 10, the graphs 600a, 600b, 600c, 600c schematically illustrate yet further aspects of embodiments of the method according to the first aspect. The graph 600a schematically illustrates the frequency (grid frequency) of the electric power grid 100. The graph 600b schematically illustrates the electric power provided by the wind turbine generator 104 to the electric power grid 100. The graph 600c schematically illustrates that the electric power consumption reduction period 602c of the Power-to-X unit 106 is initiated immediately when or after the inertia emulation response period 502b is or has been initiated, i.e. without any delay. The graph 600c schematically illustrates that the electric power consumption reduction period 602c comprises an initial period 606c and a subsequent period 608c subsequent to the initial period 606c. As schematically illustrated by the graph 600c, during the initial period 606c, the electric power consumption of the Power-to-X unit 106 is gradually reduced to the lower level, while during the subsequent period 608c, the electric power consumption of the Power-to-X unit 106 is gradually increased from the lower level. However, before the electric power consumption of the Power-to-X unit 106 is gradually increased from the lower level during the subsequent period 608c, the electric power consumption of the Power-to-X unit 106 may be maintained at the lower level during an intermediate period, as schematically illustrated by the graph 600c. The effect by the electric power consumption reduction period 602c of FIG. 10, is that the power drop 606b of the wind turbine generator 104 during the recovery period 608b in FIG. 10 is further reduced in relation to the power drop 406b of the wind turbine generator 104 of FIG. 8 and in relation to the power drop 506b of the wind turbine generator 104 of FIG. 9. The graph 600d schematically illustrates the power output from the entire power plant 100 to the electric power grid 102.

With reference to FIGS. 4 to 6 and 8 to 10, it is to be understood that after the initiation of the inertia emulation response period, of the electric power consumption reduction period or of the recovery period, the respective period continues for a certain amount of time before the termination thereof. It is to be understood that the electric power consumption reduction period at least overlaps the inertia emulation response period. For some embodiments, it may be defined that the electric power consumption reduction period continues during at least a part, or a major part, of the inertia emulation response period, for example 50 to 100% of the inertia emulation response period, such as 70 to 100% of the inertia emulation response period, or during the entire inertia emulation response period. For some embodiments, it may be defined that the electric power consumption reduction period continues in parallel to, or is active at the same time as, the inertia emulation response period at least for a certain or specific period, such as during 50 to 100% of the inertia emulation response period, for example 70 to 100% of the inertia emulation response period, or during the entire inertia emulation response period. For some embodiments, it may be defined that the electric power consumption reduction period at least overlaps the recovery period. For some embodiments, it may be defined that the electric power consumption reduction period continues during at least a part, or a major part, of the recovery period of the inertia emulation response period, for example 50 to 100% of the recovery period, such as 80 to 100% of the recovery period, or during the entire recovery period.

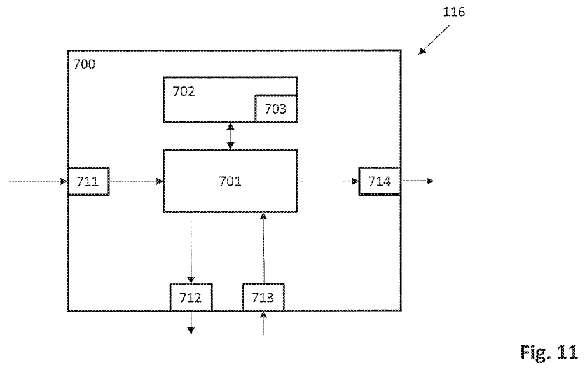

With reference to FIGS. 1 and 11, aspects of embodiments of the control arrangement 116 for controlling a power plant 100 are schematically illustrated, wherein the power plant 100 includes one or more wind turbine generators 104 and one or more Power-to-X units 106, wherein the Power-to-X unit 106 is configured to convert electric power from the power plant 100 to X, and wherein the power plant 100 is connected to an electric power grid 102. Embodiments of the control arrangement 116 are configured to:
in response to an under-frequency support request with regard to the electric power grid 102, determine 201 to initiate an inertia emulation response period of the one or more wind turbine generators 104 so as to increase the electric power generation of the wind turbine generator 104 for providing frequency support to the electric power grid 102; and
when or after it has been determined to initiate the inertia emulation response period, initiate 203a an electric power consumption reduction period of the one or more Power-to-X units 106 so as to reduce the electric power consumption of the one or more Power-to-X units 106 to a lower level or zero.

With reference to FIG. 1, the illustrated embodiment of the control arrangement 116 includes a first determination unit 116a for determining to initiate the inertia emulation response period in order to perform step 201 in FIGS. 4 to 6. The illustrated embodiment of the control arrangement 116 includes a first initiation unit 116b for initiating the electric power consumption reduction period in order to perform steps 203a, 203b, 206, 207, 208, 210 and 212 in FIGS. 4 to 6.

With reference to FIG. 1, some embodiments of the control arrangement 116 may comprise a second initiation unit 116c for initiating the inertia emulation response period in order to perform step 202 in FIGS. 5 and 6. Some embodiments of the control arrangement 116 may comprise a second determination unit 116d for determining to initiate the recovery period in order to perform step 204 in FIG. 6. Some embodiments of the control arrangement 116 may comprise a third initiation unit 116e for initiating the recovery period in order to perform step 205 in FIG. 6. Some embodiments of the control arrangement 116 may comprise a first termination unit 116f for terminating the recovery period in order to perform step 209 in FIG. 6. Some embodiments of the control arrangement 116 may comprise a second termination unit 116g for terminating the inertia emulation response period in order to perform step 211 in FIG. 6. Some embodiments of the control arrangement 116 may comprise a third termination unit 116h for terminating the electric power consumption reduction period in order to perform step 213 in FIG. 6.

With reference to FIG. 1, for some embodiments, the control arrangement 116 is configured to directly or indirectly communicate, for example via signal lines (or cables or wires) or wirelessly, with one or more of the group of: the power plant 100; the wind turbine generator 104; the electric power grid 102; sensors; and other devices or systems of the power plant 100 or of the wind turbine generator 104.

FIG. 11 shows in schematic representation an embodiment of the control arrangement 116 according to the fourth aspect of the invention, which may include a control unit 700, which may correspond to or may include one or more of the above-mentioned units 116a-h of the control arrangement 116. The control unit 700 may comprise a computing unit 701, which can be constituted by essentially any suitable type of processor or microcomputer, for example a circuit for digital signal processing (Digital Signal Processor, DSP), or a circuit having a predetermined specific function (Application Specific Integrated Circuit, ASIC). The computing unit 701 is connected to a memory unit 702 arranged in the control unit 700. The memory unit 702 provides the computing unit 701 with, for example, the stored program code and/or the stored data which the computing unit 701 requires to be able to perform computations. The computing unit 701 is also arranged to store partial or final results of computations in the memory unit 702.

With reference to FIG. 11, in addition, the control unit 700 may be provided with devices 711, 712, 713, 714 for receiving and transmitting input and output signals. These input and output signals may contain waveforms, impulses, or other attributes which, by means of the devices 711, 713 for the reception of input signals, can be detected as information and can be converted into signals which can be processed by the computing unit 701. These signals are then made available to the computing unit 701. The devices 712, 714 for the transmission of output signals are arranged to convert signals received from the computing unit 701 in order to create output signals by, for example, modulating the signals, which, for example, can be transmitted to other parts and/or systems of, or associated with, the power plant 100 (see FIG. 1). Each of the connections to the devices for receiving and transmitting input and output signals can be constituted by one or more of a cable; a data bus; and a wireless connection.

Here and in this document, units are often described as being provided for performing steps of the method according to embodiments of the invention. This also includes that the units are designed to and/or configured to perform these method steps.

With reference to FIG. 1, the units 116a-h of the control arrangement 116 are in FIG. 1 illustrated as separate units. These units 116a-h may, however, be logically separated but physically implemented in the same unit, or can be both logically and physically arranged together. These units 116a-h may for example correspond to groups of instructions, which can be in the form of programming code, that are input into, and are utilized by a processor/computing unit 701 (see FIG. 11) when the units are active and/or are utilized for performing its method step.

With reference to FIGS. 1 and 11, the control arrangement 116, which may include one or more control units 700, for example one or more devices, controllers or control devices, according to embodiments of the present invention may be arranged to perform all of the method steps mentioned above, in the claims, and in connection with the herein described embodiments. The control arrangement 116 is associated with the above-described advantages for each respective embodiment of the method.

With reference to FIG. 11, according to the second aspect of the invention, a computer program 703 is provided, comprising instructions which, when the program is executed by a computer, cause the computer to carry out the method according to one or more of the embodiments disclosed above.

According to the third aspect of the invention, a computer-readable medium is provided, comprising instructions which, when the instructions are executed by a computer, cause the computer to carry out the method according to one or more of the embodiments disclosed above.

The person skilled in the art will appreciate that the herein described embodiments of the method according to the first aspect may be implemented in a computer program 703 (see FIG. 11), which, when it is executed in a computer, instructs the computer to execute the method. The computer program is usually constituted by a computer program product 703 stored on a non-transitory/non-volatile digital storage medium, in which the computer program is incorporated in the computer-readable medium of the computer program product. The computer-readable medium comprises a suitable memory, such as, for example: ROM (Read-Only Memory), PROM (Programmable Read-Only Memory), EPROM (Erasable PROM), Flash memory, EEPROM (Electrically Erasable PROM), a hard disk unit, etc.

The present invention is not limited to the above-described embodiments. Instead, the present invention relates to, and encompasses all different embodiments being included within the scope of the independent claims.

1. A method for controlling a power plant comprising one or more wind turbine generators and one or more Power-to-X units, the Power-to-X unit being configured to convert electric power from the power plant to X, the power plant being connected to an electric power grid, wherein the method comprises:
in response to an under-frequency support request with regard to the electric power grid, determining to initiate an inertia emulation response period of the one or more wind turbine generators so as to increase the electric power generation of the wind turbine generator for providing frequency support to the electric power grid; and
when or after it has been determined to initiate the inertia emulation response period, initiating an electric power consumption reduction period of the one or more Power-to-X units so as to reduce the electric power consumption of the one or more Power-to-X units to a lower level or zero.

2. A method according to claim 1, wherein the method comprises:
after it has been determined to initiate the inertia emulation response period, initiating the inertia emulation response period; and
when or after the inertia emulation response period is or has been initiated, initiating the electric power consumption reduction period of the one or more Power-to-X units.

3. A method according to claim 1, wherein the inertia emulation response period comprises a recovery period for the wind turbine generator to regain rotational energy lost during the inertia emulation response period, and wherein the method comprises:
determining to initiate the recovery period of the one or more wind turbine generators; and
when or after it has been determined to initiate the recovery period, initiating the electric power consumption reduction period of the one or more Power-to-X units.

4. A method according to claim 3, wherein the method comprises:
after it has been determined to initiate the recovery period, initiating the recovery period of the one or more wind turbine generators; and
before initiating the recovery period, initiating the electric power consumption reduction period of the one or more Power-to-X units.

5. A method according to claim 3, wherein the method comprises:
after it has been determined to initiate the recovery period, initiating the recovery period of the one or more wind turbine generators; and
when or after the recovery period is or has been initiated, initiating the electric power consumption reduction period of the one or more Power-to-X units.

6. A method according to claim 3, wherein the method comprises:
terminating the recovery period of the one or more wind turbine generators; and
before terminating the recovery period, initiating the electric power consumption reduction period of the one or more Power-to-X units.

7. A method according to claim 1, wherein the method comprises:
terminating the inertia emulation response period; and
before terminating the inertia emulation response period, initiating the electric power consumption reduction period of the one or more Power-to-X units.

8. A method according to claim 1, wherein the method comprises:
terminating the inertia emulation response period; and
when or after the inertia emulation response period is or has been terminated, terminating the electric power consumption reduction period of the one or more Power-to-X units.

9. A method according to claim 1, wherein the electric power consumption reduction period comprises an initial period and a subsequent period subsequent to the initial period, and
wherein the method comprises:
during the initial period, gradually reducing the electric power consumption of the one or more Power-to-X units to the lower level or zero.

10. A method according to claim 1, wherein the electric power consumption reduction period comprises an initial period and a subsequent period subsequent to the initial period, and
wherein the method comprises:
during the subsequent period, gradually increasing the electric power consumption of the one or more Power-to-X units from the lower level or zero.

11. A method according to claim 1, wherein the Power-to-X unit comprises a power-to-gas unit configured to convert electric power from the power plant to gas.

12. A method according to claim 1, wherein the Power-to-X unit is configured to convert electric power to X from one or more of the group of:
a power source of the power plant;
a power generator of the power plant; and
the wind turbine generator.

13. A computer program or a computer-readable medium comprising instructions which, when the program or the instructions is/are executed by a computer, cause the computer to carry out an operation for controlling a power plant comprising one or more wind turbine generators and one or more Power-to-X units, the Power-to-X unit being configured to convert electric power from the power plant to X, the power plant being connected to an electric power grid, wherein the operation comprises:
in response to an under-frequency support request with regard to the electric power grid, determining to initiate an inertia emulation response period of the one or more wind turbine generators so as to increase the electric power generation of the wind turbine generator for providing frequency support to the electric power grid; and
when or after it has been determined to initiate the inertia emulation response period, initiating an electric power consumption reduction period of the one or more Power-to-X units so as to reduce the electric power consumption of the one or more Power-to-X units to a lower level or zero.

14. A control arrangement for controlling a power plant comprising one or more wind turbine generators and one or more Power-to-X units, the Power-to-X unit being configured to convert electric power from the power plant to X, the power plant being connected to an electric power grid, wherein the control arrangement is configured to:
in response to an under-frequency support request with regard to the electric power grid, determine to initiate an inertia emulation response period of the one or more wind turbine generators so as to increase the electric power generation of the wind turbine generator for providing frequency support to the electric power grid; and
when or after it has been determined to initiate the inertia emulation response period, initiate an electric power consumption reduction period of the one or more Power-to-X units so as to reduce the electric power consumption of the one or more Power-to-X units to a lower level or zero.

15. A power plant for providing electric power to an electric power grid, wherein the power plant comprises:
one or more wind turbine generators,
one or more Power-to-X units configured to convert electric power from the power plant to X, and
a control arrangement configured to:
in response to an under-frequency support request with regard to the electric power grid, determine to initiate an inertia emulation response period of the one or more wind turbine generators so as to increase the electric power generation of the wind turbine generator for providing frequency support to the electric power grid; and
when or after it has been determined to initiate the inertia emulation response period, initiate an electric power consumption reduction period of the one or more Power-to-X units so as to reduce the electric power consumption of the one or more Power-to-X units to a lower level or zero.

16. A computer program according to claim 13, wherein the method comprises:
after it has been determined to initiate the inertia emulation response period, initiating the inertia emulation response period; and
when or after the inertia emulation response period is or has been initiated, initiating the electric power consumption reduction period of the one or more Power-to-X units.

17. A computer program according to claim 13, wherein the inertia emulation response period comprises a recovery period for the wind turbine generator to regain rotational energy lost during the inertia emulation response period, and wherein the method comprises:
determining to initiate the recovery period of the one or more wind turbine generators; and
when or after it has been determined to initiate the recovery period, initiating the electric power consumption reduction period of the one or more Power-to-X units.

18. A control arrangement according to claim 14, wherein the control arrangement is further configured to:
after it has been determined to initiate the inertia emulation response period, initiate the inertia emulation response period; and
when or after the inertia emulation response period is or has been initiated, initiate the electric power consumption reduction period of the one or more Power-to-X units.

19. A control arrangement according to claim 14, wherein the inertia emulation response period comprises a recovery period for the wind turbine generator to regain rotational energy lost during the inertia emulation response period, and wherein the control arrangement is further configured to:
determine to initiate the recovery period of the one or more wind turbine generators; and
when or after it has been determined to initiate the recovery period, initiate the electric power consumption reduction period of the one or more Power-to-X units.

20. A power plant according to claim 15, wherein the control arrangement is further configured to:
after it has been determined to initiate the inertia emulation response period, initiate the inertia emulation response period; and
when or after the inertia emulation response period is or has been initiated, initiate the electric power consumption reduction period of the one or more Power-to-X units.
